(19) United States
(12) Patent Application Publication
(10) Pub. No.: US 2008/0242310 A1
(43) Pub. Date: Oct. 2, 2008

(54) METHOD AND APPARATUS FOR DETERMINING LOCATION OF ACCESS POINT

(75) Inventor: Dan Vassilovski, Del Mar, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/692,095

(22) Filed: Mar. 27, 2007

(51) Int. Cl. H04Q 7/20

(52) U.S. Cl. 455/456.1

(57) ABSTRACT

Method and apparatus for determining a location of an access point associated with a wireless communication network use phase measurements of a signal transmitted from an access point, at known locations to calculate the location of the access point. In some aspects, GPS information is used in conjunction with phase measurements from a signal transmitted by the access point to determine the location of such access point.

### FIELD

The present disclosure relates to wireless communication networks, and more particularly to determining location of an access point (hereinafter “AP”) associated with a wireless communication network.

### BACKGROUND

In wireless communication networks, there is a need for determining the optimal configuration, organization and operating parameters for wireless communication infrastructures. For example, proper site locations for access points such as land based radio transceivers, operating frequencies, radiated power, code assignments, handoff thresholds and operating frequencies need to be determined. Currently, wireless communication network planning requires significant a priori analysis followed by follow-on empirical verification, testing and network adjustments, which are time consuming and expensive, and require network planning experts and sophisticated tools.

In some environments and applications, such as in military and emergency applications, there may be a need for deploying additional access points, replacement access points or stand-alone autonomous wireless infrastructure access points without having sufficient time and/or resources to go through a lengthy and laborious manual planning of the network associated with these deployments. While traditional network planning focuses on the area served by the radio signal transmitted from an access point, more emphasis is placed on capacity or the number of simultaneous users supported by the access point. Additionally, In some environments and applications such as the military and emergency applications, the goal is to identify the area served by each new access point. In order to do so, the location of such access point should be known.

Thus, there exists a need to provide method and apparatus to determine a location of an access point associated with a wireless communication network.

### SUMMARY

A summary of sample aspects of the disclosure follows. For convenience, one or more aspects of the disclosure may be referred to herein simply as “some aspects.”

This application relates in some aspects to determine a location of an access point associated with a wireless communication network. To do so, a signal transmitted by a moveable access point is received. Thereafter, a phase of the received signal is determined at each of a plurality of locations so that the location of the access point can be determined based on the determined phases.

### BRIEF DESCRIPTION OF THE DRAWINGS

These and other features, aspects and advantages of the disclosure will be more fully understood when considered with respect to the following detailed description, appended claims and accompanying drawings, wherein:

FIG. 1 illustrates a wireless communication network topology;

FIG. 2 illustrates certain aspects of a wireless communication network topology;

FIG. 3 illustrates at least one mobile access point that needs to be deployed within a wireless communication;

FIG. 4 illustrates some aspects of a wireless communication network topology;

FIG. 5 illustrates exemplary details of an apparatus and an access point which location is determinable by such apparatus;

FIG. 6 is a functional blocks diagram illustrating an exemplary method being disclosed herein; and

FIG. 7 illustrates a functional blocks diagram illustrating exemplary structural components that are capable of determining a location of a access point in a wireless communication network.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

In the following description, specific details are given to provide a thorough understanding of the aspects. However, it will be understood by one of ordinary skill in the art that the aspects may be practiced without these specific detail. For example, circuits may be shown in block diagrams in order not to obscure the aspects in unnecessary detail. In other instances, well-known circuits, structures and techniques may be shown in detail in order not to obscure the aspects.

Also, it is noted that the aspects may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, as disclosed herein, a “storage medium” may represent one or more devices for storing data, including read only memory (ROM), random access memory (RAM), magnetic disk storage mediums, optical storage mediums, flash memory devices and/or other computer-readable mediums for storing information. The term “computer-readable medium” includes, but is not limited to portable or fixed storage devices, optical storage devices, wireless channels and various other mediums capable of storing, containing or carrying instruction(s) and/or data.

Furthermore, aspects may be implemented by hardware, software, firmware, middleware, microcode, or any combination thereof. When implemented in software, firmware, middleware or microcode, the program code or code segments to perform the necessary tasks may be stored in a computer-readable medium such as a storage medium. A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It should also be apparent to those skilled in the art that one or more elements or aspects of a device or an apparatus disclosed below may be rearranged without affecting the operation of the device. Similarly, one or more elements of a device disclosed below may be combined without affecting the operation of the device.

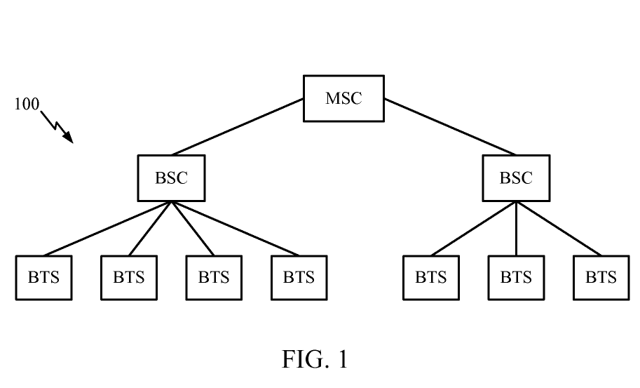

FIG. 1 illustrates a typical communication network topology 100. Communication network 100 illustrates an infrastructure topology where a number of access points such as Base Station Transceivers (BTS) are supported by one Base Station Controller (BSC), and in turn various BSCs are supported by one Mobile Switch Center (MSC). The network planning for this type of network may include some or all of the following steps:
Topographic maps of intended coverage area are analyzed;
Candidate Access point site locations and other network parameters are chosen by considering terrain and capacity requirements as function of location;
Simulation software is run to analyze network performance and capacity;
Parameters and locations are adjusted, and simulations are re-run;
After network construction, drive tests are performed to validate network coverage, capacity and performance; and
Drive test data are analyzed.
   Each step may be repeated.

The topology shown in FIG. 1 may be static in terms of its infrastructure components availability, locations, capability and so on. The planning for such network requires lengthy off-line analysis followed by communication network planning by experts using sophisticated tools designing the network to meet coverage and capacity requirements. This network design and planning can take a year or more, and after construction and network build-out, drive tests are performed to optimize and verify the performance of the network. Drive testing is typically performed by driving through an area of coverage and collecting data using an access terminal or device capable of receiving signals transmitted by the access points in the network. The collected data are usually processed real time or off line. For deployments supporting emergency response communication, military communication and so forth, this entire network planning process may be omitted due to the swift nature of the communication support.

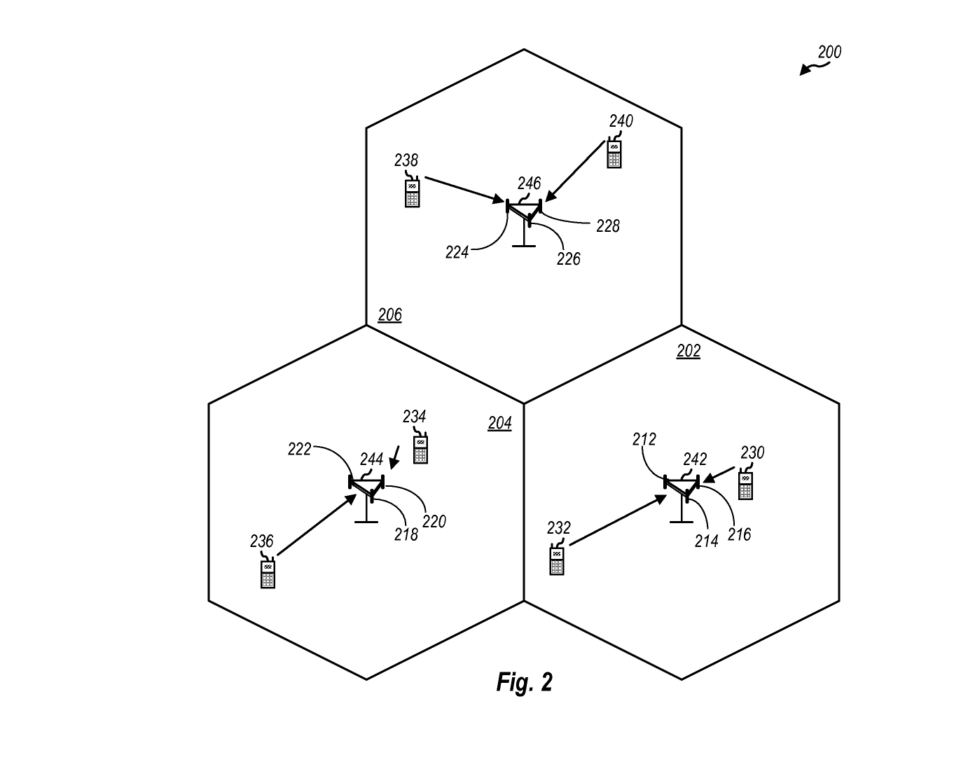

Referring to FIG. 2, a multiple access wireless communication network is illustrated. A multiple access wireless communication network 200 comprises multiple cells 202, 204, and 206. These cells 202, 204 and 206 may correspondingly comprise access points 242, 244 and 246 and each access point may be associated with multiple sectors. The multiple sectors may be formed by groups of antennas each responsible for communication with access terminals in a portion of the cell. For example, in cell 202 there are antenna groups 212, 214 and 216 and each of which corresponds to a different sector. In cell 204 there are antenna groups 218, 220, and 222 and each of which corresponds to a different sector as well. Similarly, in cell 206, there are antenna groups 224, 226 and 228 and each of which corresponds to a different sector.

It can be seen from FIG. 2 that each access terminal 230, 232, 234, 236, 238, or 240 is located in a different portion of its respective cell relative to each other access terminal in the same cell. Further, each access terminal may be a different distance from the corresponding antenna group with which it is communicatively coupled.

As used herein, an access point may be an infrastructure node that is directly communicatively coupled with at least one access terminal and may also be referred to as or included some or all of the functionalities associated with, for example, a BTS or a radio base station (RBS). An access terminal may also be referred to as, and include some or all of the functionalities associated with, a user equipment (UE), a wireless communication device, a terminal, a mobile station, personal digital assistant (PDA), a laptop computer, a handset, any device having similar functionalities as one of those previously mentioned devices or any combinations thereof.

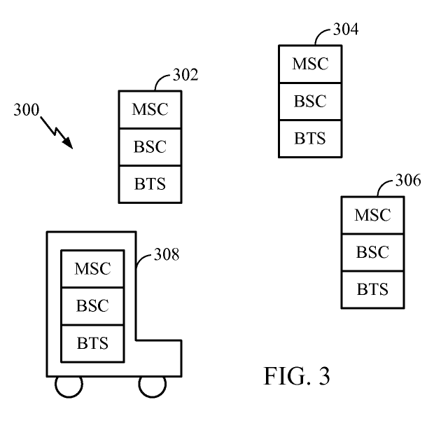

FIG. 3 illustrates a wireless communication network topology 300, for implementing some aspects of the invention. Communication network 300 illustrates a dynamic infrastructure topology where each access point may be fully self-contained; i.e., each may have full functionalities associated with a BTS, a BSC, a MSC or any combination thereof.

In some aspect, the access points may be operating in isolation from each other. For example, a vehicle-mounted BTS may be providing wireless communication coverage all by itself (autonomously) to support a rapid or rapidly changing deployment. In this case, each isolated access point is fully self-contained, having full autonomous wireless network functionalities associated with, for example, BTS, BSC and MSC and/or other functionalities to support autonomous operation. This scenario may happen in sparsely populated or rural areas with a need for emergency communication support, where a single or small number of access points may be deployed in an area with existing wireless communication infrastructure that may have been adversely affected by a natural disaster or the like or in a desert-like area with no nearby network but in which coverage is needed for access terminals being used by drivers of military vehicles.

In some aspects, the access points 302, 304, 306, 308, which may be stationary or mobile, are dynamically operating in concert to provide continuous wireless communication coverage over a wide area, similar to a commercial cellular network in an urban area, but with a dynamically varying topology an access point may require BSC and MSC functionalities. Generally, there is need for one BSC to support a group of access points. However, in rural areas or other areas without wireless communication support, a rapidly deployed access point may require and include functionalities of BSC and MSC.

In some aspects, as shown in FIG. 3, mobile access point 308, e.g., mounted on a moving object, which may have been operating isolated from other access points in a self-contained mode, enters the coverage area of access points 302, 304 and 306. Since access points 302, 304 and 306 have BSC and MSC support, the BSC and MSC functionalities of access point 308 may no longer be needed, and access point 308 may use the BSC and MSC of one or more access points 302, 304 and 306. However, when the moving access point 308 leaves the coverage area of access points 302, 304 and 306 and its movement results in it being in isolation from other access points, access point 308 may be solely used to support UEs. Since mobile access point 308 is not part of the designed network, the physical location of access point 308 may be determined when deciding whether or not to use its BSC and MSC functionalities.

In some aspects, a land-based vehicle such as an automobile with a UE or like device traverses an area covered by an access point signal by moving so as to receive the signal being transmitted by the access point in a 360° pattern or as close to 360° as possible about the access point. Information about the signal received by the UE is stored by the UE or passed from UE to a memory device that may be a part of, for example, a laptop computer. The UE determines a phase of the received signal at each of several locations known to the UE, where UE knowledge of the locations may be determined using [1] a satellite-based geo-location technique by using measurements associated with satellites of, for example, Global Positioning System (GPS), GLObal NAvigation Satellite System (GLONASS) and Galileo positioning system or [2] an inertial navigation technique; each of such measurement techniques may be implemented within the UE. Thereafter the UE uses such determined phases to determine a distance from the UE, at each of the several locations, to the access point transmitting the signal. As a result, the location of the access point can be determined by triangulation or similar methods by using the determined distances.

In some aspects, an airborne vehicle such as an airplane with a UE or like device traverses an area covered by an access point signal so as to receive the signal being transmitted by the access point in a 360° pattern or as close to 360° as possible about the access point. Information about the signal received by the UE is stored by the UE or passed from UE to a memory device for storage. The UE determines a phase of the received signal at each of several locations known to the UE and thereafter uses such determined phases to determine a distance from the UE, at each of the several locations, to the access point transmitting the signal. As a result, the location of the access point can be determined by triangulation or similar methods by using the determined distances. By using an airborne vehicle to collect information about the signal transmitted by the access point, the information needed to determine the location of the access point may be acquired much faster than collecting the information with a land based vehicle such as an automobile. Also, for deployments where one or more access points are being moved quickly to support fast moving wireless communication coverage requirements, a land based vehicle may not be capable of providing the appropriate information quickly enough to support communication requirements.

In some aspects, determining the location of an access point may be accomplished by taking advantage of GPS functionality of a UE. In several aspects, the location of an access point is determined relative to the UE. For UEs that collect GPS information, the GPS information is stored with the received signal information. In some aspects, the GPS location provided by the UE may be plotted and the phase of the signal transmitted by an access point at each of several plotted points may be used to determine the location of the access point.

In some aspects, the wireless communication network may use Code Division Multiple Access (CDMA) as the radio signal technology. Each access point in a CDMA communication network transmits a CDMA signal that has a unique Pseudo Noise (PN) code. The phase of the signal transmitted by a particular CDMA access point is determined by using information from the PN.

In order to support requirements of enhanced 911 services in the United States, operators of CDMA networks have implemented a hybrid position-location solution combining UE-based GPS measurements with UE- and network-based measurements. An example of this solution is known as gpsOne®. A network-based measurement mechanism used by gpsOne is Advanced Forward-Link Trilateration (ALFT). An AFLT-capable UE can provide phase measurements of pilot signals of the access point to a resolution up to eight times finer than pilot phase measurements made by non-AFLT-capable UEs, and provide phase measurements of a greater number of pilots than typically made by non-AFLT-capable UEs. UE-provided gpsOne measurements, which may comprise UE-based GPS measurements and UE-based pilot phase measurements of access points for which the UE can detect pilot signals, are provided to a network entity or node that converts the pilot phase measurements to distance measurements and calculates a UE position by combining the GPS and network pilot phase measurements using an algorithm to rank the GPS and pilot phase measurements.

In some aspects, an access point in a CDMA network receives a GPS signal. If the access point receives the appropriate GPS signals, the location of the access point can be derived from the GPS signals. There are, however, environments in which an access point cannot receive the GPS signals needed to derive its location. This may be true of environments that require swift deployments of one or more access points, wherein time is of the essence to analyze possible deployable locations for an access point, as well as deployments associated with rapid changes of the access point location or in which independent determination, verification or both determination and verification of an access point location may be needed. If an access point receives less than the appropriate number of GPS satellite signals, the GPS information received by the access point may be used along with the distance information derived from the phase of the signal received at the UE to determine the location of the access point, or the UE-based phase measurements may be used to independently determine access point location.

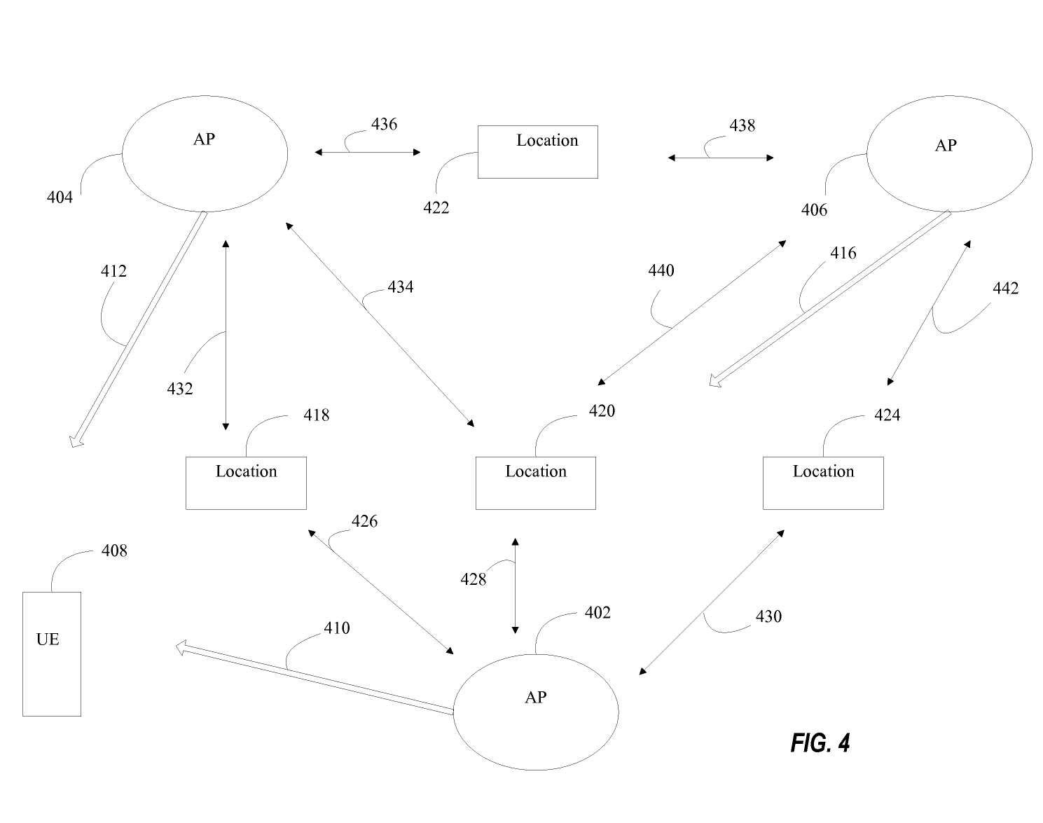

Referring to FIG. 4, a multiple access wireless communication network is illustrated. Access point 402 is a mobile access point deployed to provide quick response communication support. Knowledge about the location of the access point may be required to determine the area of communication service provided by the access point. UE 408 receives a pilot signal 410 transmitted by access point 402. UE 408 records the phase of pilot signal 410 at multiple locations including but not limited to locations 418, 420 and 424. The phase of the pilot signal 410 at each location is used to determine the distance from each location to the access point 402. By knowing its locations 418, 420 and 424 and distances 426, 428 and 430 from each location to the access point 402, UE 408 can calculate the location of the access point 402.

In some aspects, UE 408 receives pilot signals from access points 402, 404 and 406. Using the phase of the pilot signal 412 from access point 404 at locations 418, 420 and 422, distances 432, 434 and 436 from the locations to the access point are determined. By knowing its locations 418, 420 and 422, and the distances 432, 434 and 436 from such locations to the access point 404, the UE 408 can determine the location of access point 404. A similar process is used to determine the location of access point 406. The phase of the pilot signal 416 transmitted from access point 406 is measured at each of locations 420, 422 and 424. The phase of the pilot signal 416 measured at each of the locations 420, 422 and 424, is used to determine distances 438, 440 and 442 from such locations to the access point 406. By knowing its locations and the corresponding distances, UE 408 can determine the location of the access point 406. The distance measurements associated with locations 418, 420 and 422 are illustrative of the multiple measurements required to use well-known triangulation methods to determine a location of an access point for which phase measurements are made.

In an aspect, UE 408 receives a pilot signal 410 from access point 402. The UE 408 measures the phase of the pilot signal 410 at known locations 418, 420, and 430. Using the information from the measured pilot signal and GPS signal, the same algorithms used for AFTL may be used to determine the location access point 402. This method may be applied when determining the location of multiple access points such as access points 402, 404 and 406 as illustrated in FIG. 4.

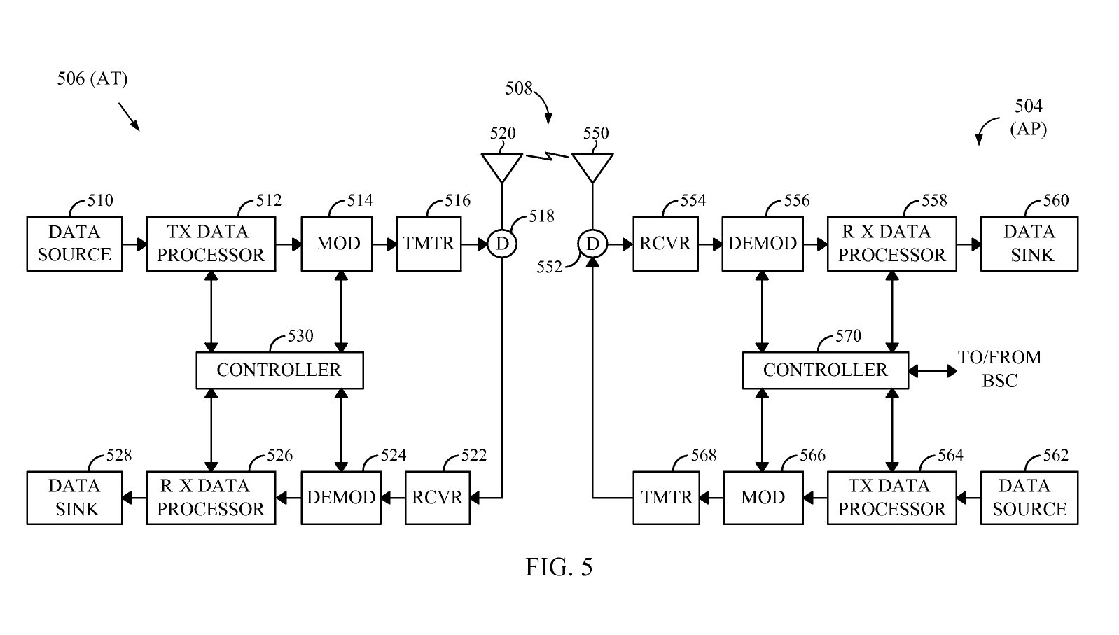

FIG. 5 is a simplified, sample blocks diagram illustrating an infrastructure access point 504 and a communication device 506 that is capable of implementing various disclosed aspects. For a particular media communication, voice, data, packet data, and/or alert messages may be exchanged between the infrastructure access point 504 and communication device 506, via an air interface 508. Various types of messages may be transmitted. For example, such messages comprise messages used to establish a communication session between the access point and the communication device, registration and paging messages, and messages used to control a data transmission (e.g., power control, data rate information, acknowledgment and so on). Some of these message types are described in further detail below.

For the reverse link, at communication device 506, voice and/or packet data (e.g., from a data source 510) and messages (e.g., from a controller 530) are provided to a transmit (TX) data processor 512, which formats and encodes the data and messages with one or more coding schemes to generate coded data. Each coding scheme may include any combination of cyclic redundancy check (CRC), convolutional, turbo, block, and other coding, or no coding at all. The voice, packet data, and messages may be coded using different schemes, and different types of messages may be coded differently.

The coded data are then provided to a modulator (MOD) 514 and are further processed (e.g., covered, spread with short PN sequences, and scrambled with a long PN sequence assigned to the communication device). The modulated data are then provided to a transmitter unit (TMTR) 516 and conditioned (e.g., converted to one or more analog signals, amplified, filtered, and quadrature modulated) to generate a reverse link signal. The reverse link signal is routed through a duplexer (D) 518 and transmitted via an antenna 520 to the infrastructure access point 504.

At the infrastructure access point 504, the reverse link signal is received by an antenna 550, routed through a duplexer 552, and provided to a receiver unit (RCVR) 554. Alternatively, the antenna may be part of the wireless operator network, and the connection between the antenna and the BS/BSC may be routed through the Internet. The infrastructure access point 504 may receive media information and alert messages from communication device 506. Receiver unit 554 conditions (e.g., filters, amplifies, down converts, and digitizes) the received signal and provides samples. A demodulator (DEMOD) 556 receives and processes (e.g., despreads, decovers, and pilot demodulates) the samples to provide recovered symbols. Demodulator 556 may implement a rake receiver that processes multiple instances of the received signal and generates combined symbols. A receive (RX) data processor 558 then decodes the symbols to recover the data and messages transmitted on the reverse link. The recovered voice/packet data are provided to a data sink 560 and the recovered messages may be provided to a controller 570. Controller 570 may include instructions for receiving and sending information, receiving and sending responses to messages, identifying availability, capability, location, and/or presence of infrastructure resources, locating infrastructure access points, determining the types of infrastructure resources, reconfiguring the network parameters, determining network parameters based on forward link communication received from other access points, adjusting operating conditions based on network parameters received from other access points, and recovering infrastructure resources. The processing by demodulator 556 and RX data processor 558 is complementary to that performed at remote access device 506. Demodulator 556 and RX data processor 558 may further be operated to process multiple transmissions received via multiple channels, e.g., a reverse fundamental channel (R-FCH) and a reverse supplemental channel (R-SCH). Also, transmissions may be simultaneously from multiple communication devices, each of which may be transmitting on a reverse fundamental channel, a reverse supplemental channel, or both.

On the forward link, at the infrastructure access point 504, voice and/or packet data (e.g., from a data source 562) and messages (e.g., from controller 570) are processed (e.g., formatted and encoded) by a transmit (TX) data processor 564, are further processed (e.g., covered and spread) by a modulator (MOD) 566, and thereafter are conditioned (e.g., converted to analog signals, amplified, filtered, and quadrature modulated) by a transmitter unit (TMTR) 568 to generate a forward link signal. The forward link signal is routed through duplexer 552 and transmitted via antenna 550 to remote access device 506. Forward link signals include paging signals.

At communication device 506, the forward link signal is received by antenna 520, routed through duplexer 518, and provided to a receiver unit 522. Receiver unit 522 conditions (e.g., down converts, filters, amplifies, quadrature modulates, and digitizes) the received signal and provides samples. The samples are processed (e.g., despreaded, decovered, and pilot demodulated) by a demodulator 524 to provide symbols, and the symbols are further processed (e.g., decoded and checked) by a receive data processor 526 to recover the data and messages transmitted on the forward link. The recovered data are provided to a data sink 528, and the recovered messages may be provided to controller 530. Controller 530 may include instructions for receiving and sending information, receiving and sending responses to messages, identifying availability, capability, location, and/or presence of infrastructure resources, locating infrastructure access points, determining the types of infrastructure resources, reconfiguring the network parameters, determining network parameters based on forward link communication received from other access points, adjusting operating conditions based on network parameters received from other access points, and recovering infrastructure resources.

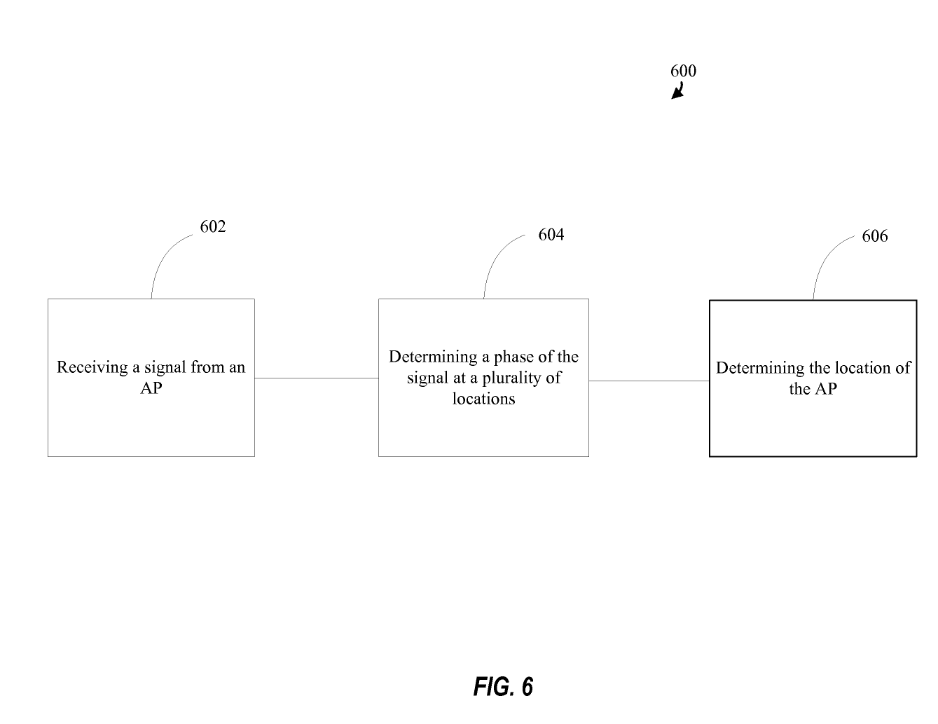

Referring to FIG. 6, a functional blocks diagram 600 illustrating a method for locating an access point associated with a wireless communication network. A signal transmitted by an access point is received at 602. Then, a phase of the signal, at each of a plurality of locations, is determined at 604, and thereafter a location of the access point is determined based on the determined phases of the signal at 606.

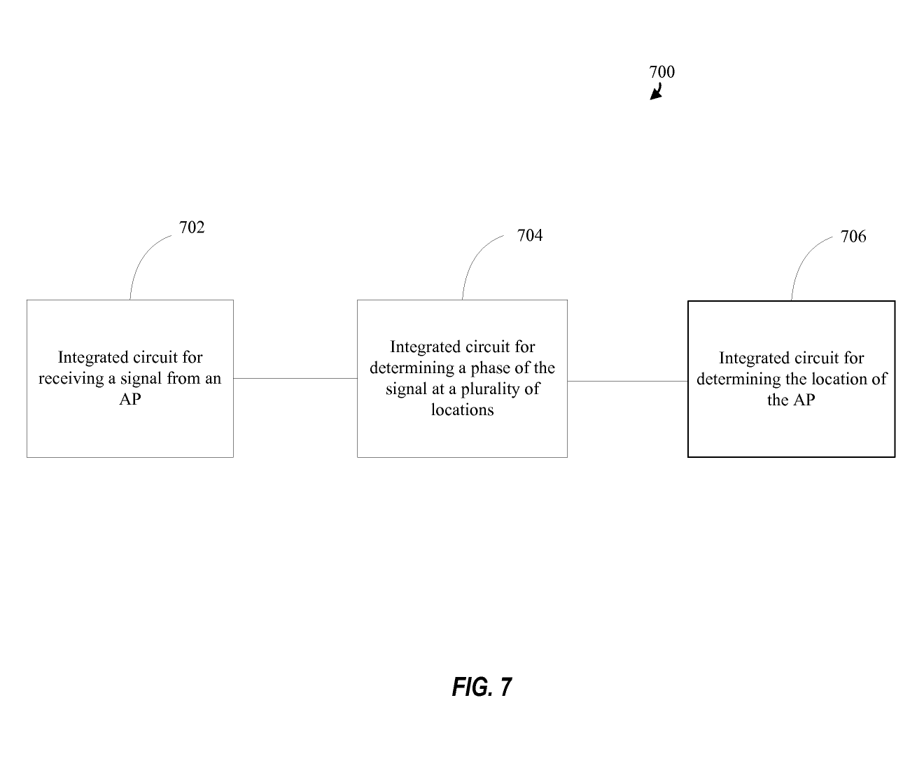

Referring to FIG. 7, a functional blocks diagram 700 illustrating a sample apparatus for determining a locating an access point associated with a wireless communication network. The apparatus 700 comprises an integrated circuit 702 for receiving a signal transmitted by an access point, an integrated circuit 704 for determining a phase of the signal, at each of a plurality of locations and an integrated circuit 706 for determining a location of the access point based on the determined phases of the signal. One integrated circuit may comprise functionalities of all three integrated circuits 702, 704 and 706.

A device or an apparatus may comprise various components that facilitate communicating with another device. For example, a device may comprise a transceiver (e.g., radio) with associated transmitter and receiver components that include various components (e.g., signal generators and signal processors) that facilitate communication over a wireless medium.

A device may employ a variety of wireless physical layer schemes. For example, the physical layer may utilize some form of CDMA, TDMA, OFDM, OFDMA, or other modulation and multiplexing schemes.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall network. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”) or an access terminal. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

As discussed above, steps of a method or algorithm described in connection with the aspects disclosed herein may be embodied directly in hardware, in a software module executed by a processor, or in a combination of the two. A software module (e.g., including executable instructions and related data) and other data may reside in a storage medium (e.g., data memory) such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

1. A method of determining a location of an access point in a wireless communication network, comprising:
receiving a signal transmitted by a access point;
determining a phase of the signal at each of a plurality of locations; and
determining a location of the access point based on the determined phases.

2. The method of claim 1, wherein the phase determination comprises:
determining a distance from each of the plurality of locations to the access point based on the determined phase.

3. The method of claim 1, wherein the signal transmitted by the access point is a pilot signal.

4. The method of claim 1, wherein the phase determination comprises:
determining a variation associated with a Pseudo Noise (PN) code assigned to the access point.

5. The method of claim 1, wherein determining the location of the access point further comprises using Global Position Network (GPS) information.

6. The method of claim 1, wherein the plurality of locations are known locations derived from measurements associated with satellites.

7. The method of claim 1, wherein the plurality of locations are known locations derived from inertial navigation information.

8. The method of claim 1, wherein the method is performed by at least one of an access terminal, a laptop computer and a PDA.

9. An apparatus for determining a location of an access point in a wireless communication network comprising:
a receiver adapted to receive a signal transmitted by a access point;
a phase determining module adapted to determine a phase of the signal at each of a plurality of locations; and
a location determining module adapted to determine a location of the access point based on the determined phases.

10. The apparatus of claim 9, wherein the phase determining module is further adapted to determine a distance from each of the plurality of locations to the access point based on the determined phase.

11. The apparatus of claim 9, wherein the signal transmitted by the access point is a pilot signal.

12. The apparatus of claim 9, wherein the phase determining module is further adapted to determine a variation associated with a Pseudo Noise (PN) code assigned to the access point.

13. The apparatus of claim 9, wherein:
the receiver receives GPS information; and
the location module configured to determine the location of the access point based on the GPS information.

14. The apparatus of claim 9, wherein the plurality of locations are known locations derived from measurements associated with satellites.

15. The method of claim 9, wherein the plurality of locations are known locations derived from inertial navigation information.

16. The apparatus of claim 9, wherein the apparatus comprises at least one of an access terminal, a laptop computer and a PDA.

17. An apparatus for determining a location of an access point in a wireless communication network comprising:
means for receiving a signal transmitted by a access point;
means for determining a phase of the signal at each of a plurality of locations; and
means for determining the location of the access point based on the determined phases.

18. The apparatus of claim 17, wherein the phase determining means further determines a distance from each of the plurality of locations to the access point based on the determined phase.

19. The apparatus of claim 17, wherein the signal received by the receiving means is a pilot signal.

20. The apparatus of claim 17, wherein the phase determining means further determines a variation associated with a Pseudo Noise (PN) code assigned to the access point

21. The apparatus of claim 17, wherein:
the receiving means receives GPS information; and
the location determining means determines the location of the access point based on the GPS information.

22. The apparatus of claim 17, wherein the plurality of locations are known locations derived from measurements associated with satellites.

23. The method of claim 17, wherein the plurality of locations are known locations derived from inertial navigation information.

24. The apparatus of claim 17, wherein the apparatus comprises at least one of an access terminal, a laptop computer and a PDA.

25. A computer program product for determining a location of an access point associated with a wireless communication network comprising:
a computer-readable medium comprising codes executable by at least one computer to:
receive a signal transmitted by a access point;
determine a phase of the signal received at each of a plurality of locations; and
determine the location of the access point based on the determined phase of the signal received.

26. A access terminal for determining a location of an access point associated with a wireless communication network comprising:
a receiver adapted to receive a signal transmitted by a access point;
a phase determining module adapted to determine a phase of the signal at each of a plurality of locations;
a location determining module adapted to determine a location of the access point based on the determined phases; and
a user interface adapted to display the determined location of the access point associated with the wireless communication network.
